(19) United States
(12) Patent Application Publication
(10) Pub. No.: US 2010/0071408 A1
(43) Pub. Date: Mar. 25, 2010

(54) METHOD OF RECYCLING LiCl SALT WASTES BY USING LAYER CRYSTALLIZATION AND APPARATUS FOR THE SAME

(75) Inventors: Yung-Zun Cho, Daejeon (KR); In-Tae Kim, Daejeon (KR); Han-Soo Lee, Daejeon (KR)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignees: Korea Atomic Energy Research Institute, Daejeon (KR); korea Hydro and Nuclear Power Co., Ltd., Seoul (KR)

(21) Appl. No.: 12/500,869

(22) Filed: Jul. 10, 2009

(30) Foreign Application Priority Data
Sep. 24, 2008 (KR) 10-2008-0093470

(51) Int. Cl. B01D 9/04; C02F 1/22; F25D 23/00

(52) U.S. Cl. 62/532; 62/540; 62/544; 62/123; 62/455

(57) ABSTRACT

Disclosed herein are a method of recycling LiCl salt wastes comprising radionuclides and an apparatus using the same. The method includes a) solidifying a LiCl salt contained in the LiCl salt wastes and contacting the outer wall of a housing, by charging a crystallizer comprising the housing having an internal accommodating space and an air cooler in the internal accommodating space into a crystallizing furnace accommodating the LiCl salt wastes comprising the radionuclides, and by cooling the housing to a temperature of two-phase region where the liquid state and the solid state of the LiCl salt waste coexist, b) separating the crystallizer where the LiCl salt is solidified from the crystallizing furnace, c) recycling the LiCl salt by heating the separated crystallizer to melt the solidified LiCl salt.

### CROSS-REFERENCES TO RELATED APPLICATION

This patent application claims the benefit of priority from Korean Patent Application No. 10-2008-0093470, filed on Sep. 24, 2008, the contents of which are incorporated herein by reference.

### BACKGROUND OF THE INVENTION

1. Field of the Invention

The present disclosure relates to a method of recycling LiCl salt wastes including radionuclides and an apparatus for the same.

2. Description of the Related Art

In a process of electro-reduction of nuclear fuel, LiCl salt wastes including nuclides of group I (Cs) and group II (Sr) are generated. Since both Cs and Sr are highly exothermic nuclides, the LiCl salt wastes generated from the electro-reduction process must be permanently disposed of after being processed into a stable solidified body for final disposal. In this case, because the entirety of LiCl salt wastes must be solidified, the volume of the final solidified body is significantly increased.

Accordingly, if only Cs/Sr are removed from LiCl salt wastes, and most of the remaining LiCl salt is recycled in an electro-reduction process, then the volume of the solidified body for final disposal may be significantly reduced.

While studies for removal Cs and Sr included in LiCl salt wastes are underway, as of yet there have been no reports of favorable separation efficiency results obtained that are realistically applicable.

Studies are currently being conducted on a technology for separating Cs/Sr from salt using zeolite through an ion exchange process. However, this process may be applied to a eutectic salt (for example, LiCl and KCl eutectic salt) of a low operation temperature because of its melting temperature of about 610° C., but may not be applied to LiCl salt wastes operated at a temperature of about 650° C. because the structure of zeolite is disintegrated.

Also, studies have been conducted on separation from salt after transforming Cs, Sr, and Ba into phosphorus oxides. However, Sr and Ba indicated high phosphorylating efficiency, while Cs indicated a very low transformation rate and, generated Cs phosphorus oxide is impossible to separate due to its high solubility with respect to salt.

Studies have been conducted on a method of removing Sr and Ba from an LiCl salt using carbonates (for example, Li2CO3). While indicating high transformation efficiency of about 99% in group II nuclides (Sr and Ba), this method indicated very low efficiency in Cs. Accordingly, it is impossible to remove group I and II nuclides simultaneously.

Moreover, although the method of adding chemical agents shows a high transformation rate, a large amount of chemical agents must be added to obtain a high transformation rate. In this case, excessively added chemical agents that remain unreacted in LiCl salt make it difficult in practice for the LiCl salt to be recycled in an electro-reduction process.

### SUMMARY OF THE INVENTION

As described above, a related-art method of separating Cs and Sr included in LiCl salt has a limitation in separation efficiency.

One object of the present invention is to provide a method of recycling LiCl salt wastes including radionuclides and an apparatus using the same, by separating poor LiCl salt from the LiCl salt wastes including radionuclides.

Another object of the present invention is to provide a method of recycling LiCl salt wastes including radionuclides and an apparatus using the same, by separating pure LiCl salt from the LiCl salt wastes including at least one radionuclide selected from Cs and Sr groups through a simple process and a relatively short processing time.

In order to achieve the objects, the present invention provides a method of recycling radioactive salt wastes using layer crystallization including solidifying LiCl salt by cooling LiCl salt wastes including liquefied radionuclides to a temperature of a two-phase region where the liquid state and the solid state of the LiCl salt waste coexist.

A method of recycling radioactive salt wastes according to an embodiment requires a simple process and a relatively short processing time. Accordingly, the method has an economical efficiency, and also has an advantage capable of separating radionuclides from the salt wastes at a concentration of about 80% or more, and obtaining a solidified pure LiCl salt.

The present invention also provides a method of recycling LiCl salt wastes comprising radionuclides, the method comprising:

a) solidifying a LiCl salt contained in the LiCl salt wastes and contacting the outer wall of a housing, by charging a crystallizer comprising the housing having an internal accommodating space and an air cooler in the internal accommodating space into a crystallizing furnace accommodating the LiCl salt wastes comprising the radionuclides, and by cooling the housing to a temperature of two-phase region where the liquid state and the solid state of the LiCl salt waste coexist;

b) separating the crystallizer where the LiCl salt is solidified from the crystallizing furnace; and

c) recycling the LiCl salt by heating the separated crystallizer to melt the solidified LiCl salt.

More specifically, the radionuclide may be at least one selected from Cs and Sr groups. The solidifying of the LiCl salt may include cooling the housing to a temperature from about 490° C. to about 610° C. The above processing may be repeatedly performed.

Probability of separating Cs and Sr from LiCl salt wastes including radionuclides may be predicted through the phase diagram. FIG. 1 shows a three-component phase diagram of LiCl—CsCl—SrCl₂. In FIG. 1, contents of CsCl and SrCl₂ corresponds to a case of about 0.513 weight % and about 0.242 weight % (FIG. 1(A)), and a case of about 4.37 weight % and about 2.05 weight % (FIG. 1(B)). As illustrated in FIG. 1, if LiCl salt wastes including Cs and Sr are cooled to a temperature of about 490° C. to about 610° C. at any concentration range, highly pure LiCl salt may be solidified. Accordingly, the temperature of the housing may be cooled at the above temperature range to solidify LiCl salt. When the temperature is less than about 490° C., a large amount LiCl salt may be solidified. In this case, however, the excessive cooling may cause poor separation efficiency of Cs and Sr.

The solidifying of the LiCl salt may include cooling the housing by passing a cooling air through the cooler via an inlet and an outlet in the crystallizer. In the solidifying of the LiCl salt, solidification (or crystallization) characteristics of the LiCl may be known by a temperature change of the outlet discharging the cooling air. As the processing operation progresses, that is, the LiCl salt is solidified on the surface of the crystallizer, the temperature of the outlet decreases after reaching its maximum value Tₘₐₓ. In this case, when a temperature difference ΔT between the maximum value Tₘₐₓ and the minimum value Tₘᵢₙ is from about 10° C. to about 20° C., the degree of purity of the solidified LiCl salt may be relatively high, and the separation efficiency of Cs and Sr may be greater. When the temperature difference ΔT is beyond about 20° C., a desired separation efficiency of radionuclides may not be achieved due to poor solidification of the LiCl salt.

In the separating of the crystallizer, the LiCl salt solidified in the crystallizer may reach about 80% to about 95% of the total weight of the LiCl salt waste comprising the radionuclides. The solidified LiCl salt may be recycled in an electro-reduction process. The present invention has the advantage of being environment-friendly because the amount of the LiCl salt wastes including radionuclides is effectively reduced by separating the solidified LiCl salt from the LiCl salt wastes.

In the solidifying of the LiCl salt, a crystal growing rate of the solidified LiCl salt may range from about 2 g/min to about 6 g/min. If the crystal growing rate exceeds 6 g/min, a separation between the radionuclides and the LiCl salt may not be inefficient. If the crystal growing rate is less than 2 g/min, the processing time may be delayed.

In the solidifying of the LiCl salt, the initial temperature of the LiCl salt waste including the radionuclide may range from about 650° C. to about 710° C. In this case, the LiCl salt wastes may be maintained liquefied, and may not be excessively cooled to increase the degree of purity of the solidified LiCl salt.

In the solidifying of the LiCl salt, when the crystallizer is charged into the crystallizing furnace, the LiCl salt solidified on the housing of the crystallizer may be spaced a certain distance from the inner wall of the crystallizing furnace.

In the recycling of the LiCl salt, the crystallizer may be separated from the crystallizing furnace to be re-charged into the melting furnace, where the crystallizer may be heated to re-melt the solidified LiCl salt. The melting temperature may range from about 700° C. to about 800° C.

The present invention also provides an apparatus of recycling LiCl salt wastes including at least one radionuclide selected from Cs and Sr groups. Hereinafter, detailed description thereof will be described.

The present invention also provides an apparatus of recycling LiCl salt wastes including at least one radionuclide selected from Cs and Sr groups, the apparatus comprising:

a crystallizing furnace accommodating the LiCl salt wastes comprising the radionuclide;

a crystallizer charged into the LiCl salt wastes comprising the radionuclide accommodated in the crystallizing furnace, comprising a housing having an internal accommodating space, comprising an air-cooler in the internal accommodating space, and solidifying a LiCl salt of the LiCl salt wastes contacting an outer wall of the housing by cooling the housing using the air cooler; and

a melting furnace separating the LiCl salt from the radionuclide by accommodating the crystallizer where the LiCl salt separated from the crystallizing furnace is solidified and melting the solidified LiCl salt on the outer wall of the housing.

The crystallizer may include: an inlet supplying a cooling air to the internal accommodating space of the housing; a baffle maintaining the internal accommodating space of the housing at a predetermined temperature by diffusing the cooling air; and an outlet discharging the cooling air supplied to the internal accommodating space of the housing.

The LiCl salt in the LiCl salt wastes including the radionuclides may be solidified on the outer wall of the crystallizer. Here, if the housing is cooled by uniform temperature, the LiCl salt may be uniformly solidified in an axis direction. For this, the baffle is provided to diffuse the cooling air for a uniform flow in the axis direction. A plurality of baffles may be laterally and alternately arranged to form a cooling air-flow path having a zigzag pattern.

The crystallizer may further include a thermometer for measuring the temperature of the cooling air accommodated in the housing. The crystallizer may further include a flow regulator for maintaining the internal accommodating space of the housing at a predetermined temperature by regulating a flow rate of a cooling air supplied from the inlet and a flow rate of a cooling air discharged to the outlet.

A plurality of thermometers may be provided to measure the temperature of the cooling air. One thermometer may be located at the outlet discharging the cooling air. Also, another thermometer may be located at the crystallizing furnace to measure the temperature of the LiCl salt wastes including the radionuclides.

The crystallizing furnace may further include a heater for heating the accommodated LiCl salt waste to prevent an excessive cooling by the crystallizer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a three-component phase diagram of LiCl—CsCl—SrCl₂.

FIG. 2 is a diagram illustrating an apparatus of recycling LiCl salt waste including radionuclides.

FIG. 2(a) is a diagram illustrating that LiCl salt wastes including radionuclides are solidified into a LiCl salt.

FIG. 2(b) is a diagram illustrating that the solidified LiCl salt is re-melted in a furnace.

FIG. 3 is a diagram illustrating a distribution efficiency coefficient and removal rate of Cs/Sr in a solidified salt according to the Example 1 of the present invention.

FIG. 4 is a diagram illustrating a crystal growing rate of a solidified LiCl salt according to the Example 1 of the present invention.

FIG. 5(a) is a graph illustrating changes of temperature (Out T (° C.)) of an outlet of a crystallizer and temperature (salt T (° C.)) of LiCl wastes including radionuclides according to Comparative Example 1 of the present invention.

FIG. 5(b) is a graph illustrating changes of temperature (Out T (° C.)) of an outlet of a crystallizer and temperature (salt T (° C.)) of LiCl wastes including radionuclides according to comparative example 2 of the present invention.

FIG. 5(c) is a graph illustrating changes of temperature (Out T (° C.)) of an outlet of a crystallizer and temperature (salt T (° C.)) of LiCl wastes including radionuclides according to the Example 1 of the present invention.

100: crystallizing furnace

150: heater

200: melting furnace

300: crystallizer

310: housing

320: inlet

330: flow regulator

340: outlet

350: thermometer

360: baffle

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical sprit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

Hereinafter, the present invention will be described in detail.

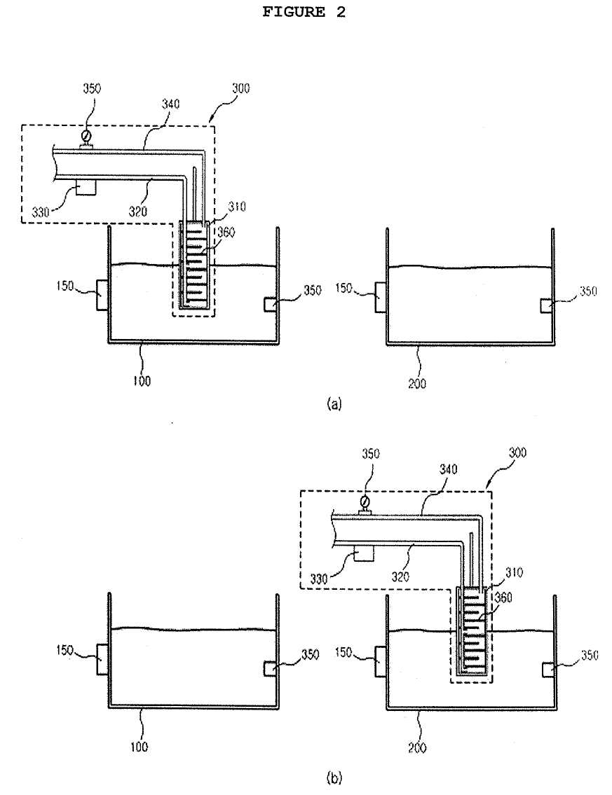

FIG. 2 is a diagram illustrating an apparatus of recycling radioactive salt waster of LiCl salt waste including at least one radionuclide selected from Cs and Sr groups according to the present invention. As illustrated in FIG. 2, an apparatus of recycling LiCl salt wastes comprising at least one radionuclide selected from Cs and Sr groups includes a crystallizing furnace 100, a crystallizer 300, and a melting furnace 200. The crystallizing furnace 100 accommodates the LiCl salt wastes comprising the radionuclide. The crystallizer 300 is charged into the LiCl salt wastes comprising the radionuclide accommodated in the crystallizing furnace 200, includes a housing 310 having an internal accommodating space, includes an air-cooler in the internal accommodating space, and solidifies a LiCl salt of the LiCl salt wastes contacting an outer wall of the housing 310 by cooling the housing 310 using the air cooler. The melting furnace 200 separates the LiCl salt from the radionuclide by accommodating the crystallizer 300 where the LiCl salt separated from the crystallizing furnace 200 is solidified and melting the solidified LiCl salt on the outer wall of the housing. The crystallizing furnace and the melting furnace are formed of a material such as alumina. In this embodiment, alumina was used as an example. The crystallizer is formed of a material such as inconel having strong thermal and corrosion resistance.

The crystallizer 300 includes an inlet 320, a baffle 360, and an outlet 340. The inlet 320 supplies a cooling air to the internal accommodating space of the housing 310. The baffle 360 maintains the internal accommodating space of the housing 310 at a predetermined temperature by diffusing the cooling air. The outlet 340 discharges the cooling air supplied to the internal accommodating space of the housing 310. A plurality of baffles 360 are laterally and alternately arranged at an interval of about 10 mm to form a cooling air-flow path having a zigzag pattern. The crystallizer 300 further comprises a thermometer 350 for measuring the temperature of the cooling air accommodated in the housing 310. The thermometer 350 is located at an inner side of the outlet 340. The crystallizer further comprises a flow regulator 330 for maintaining the internal accommodating space of the housing 310 at a predetermined temperature by regulating a flow rate of a cooling air supplied from the inlet 320 and a flow rate of a cooling air discharged to the outlet 340. The crystallizing furnace 100 further comprises a heater 150 for heating the accommodated LiCl salt waste to prevent an excessive cooling by the crystallizer 300. The crystallizing furnace 110 and the melting furnace 200 include a thermometer 350.

FIG. 2(a) is a diagram illustrating that the crystallizer 300 is charged into the crystallizing furnace 100. Here, the LiCl salt wastes including radionuclides are cooled to form a solidified LiCl salt on the outer wall of the crystallizer 300. FIG. 2(b) is a diagram illustrating that the crystallizer 330 separated from the crystallizing furnace 100 is charged into the melting furnace 200. Here, the solidified LiCl salt on the outer wall of the crystallizer 300 is re-melted in the melting furnace 200.

### THE EXAMPLE 1

Example of Solidifying LiCl Salt and Separating the LiCl Salt from LiCl Salt Wastes including Cs and Sr using a Similar Apparatus to that in FIG. 2

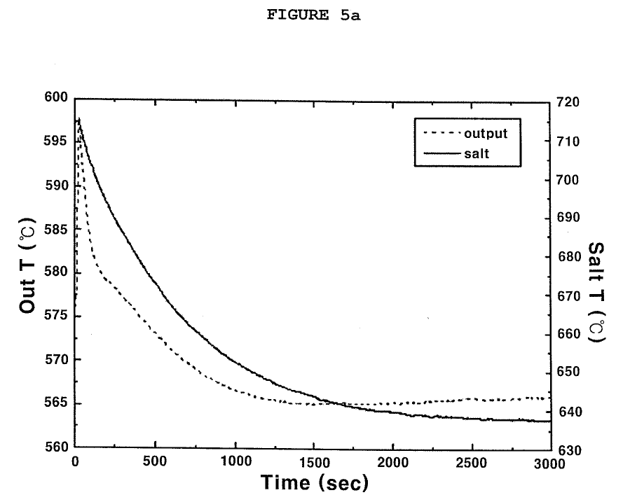

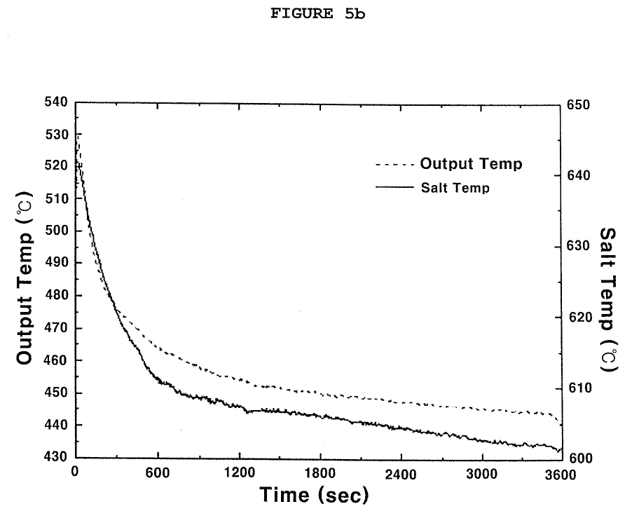

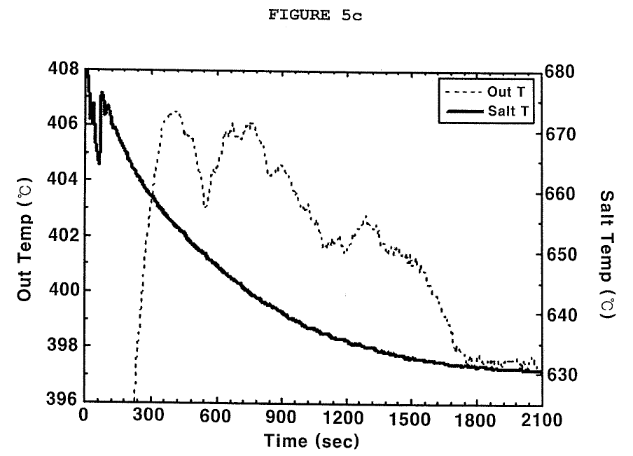

After LiCl salt 2000 g containing CsCl and SrCl of 1 weight %, respectively, was poured into a crystallizing furnace, which is a cylindrical alumina vessel having the inside diameter of 110 mm and the height of 250 mm, a crystallizer having the inside diameter of 70 mm and the height of 200 mm was inserted into the crystallizing furnace. Then, a cooling air having an initial temperature of about 25° C. was poured into the crystallizer at a flow rate of about 25 L/min. The crystallizing furnace was maintained at an initial temperature of about 680° C. by a heater to maintain the LiCl salt wastes to be in liquid state without being excessively cooled. FIG. 5 shows changes of temperatures of an outlet of the crystallizer and the LiCl salt wastes until the solidification of the LiCl salt wastes is finished. FIG. 5(c) shows a result of high nuclide separation efficiency. In this case, temperature of a cooling air was about 25° C., and was injected at a flow rate of about 25 L/min. The initial temperature of salt wastes was 680° C. The operation was stopped when the temperature change ΔT was about 12° C. in the solidification (or crystallization) process. At the time of stopping the operation, the temperature of the LiCl salt wastes was about 630° C.

After solidification (or crystallization) is once completed, the crystallizer including the solidified LiCl salt was transferred from the crystallizing furnace to a melting furnace. Then, the temperature of the melting furnace was increased to about 705° C. to melt and remove the solidified (or crystallized) LiCl salt on the surface of the crystallizer. These operations were repeated until only 10 weight % of the total LiCl salt waste remained.

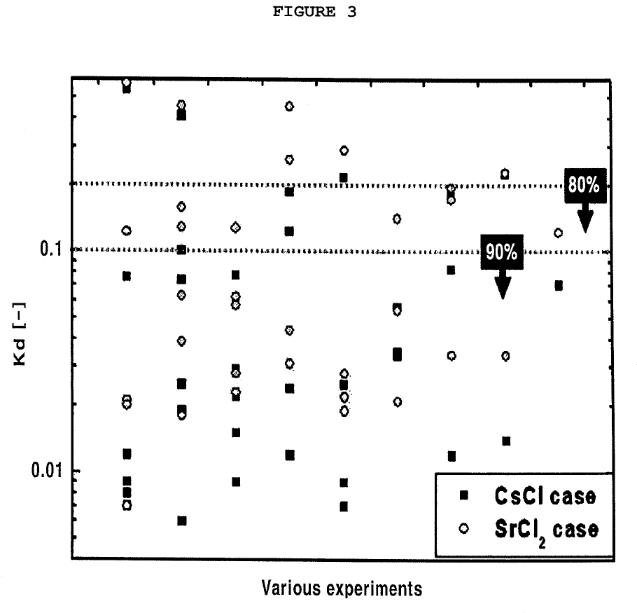

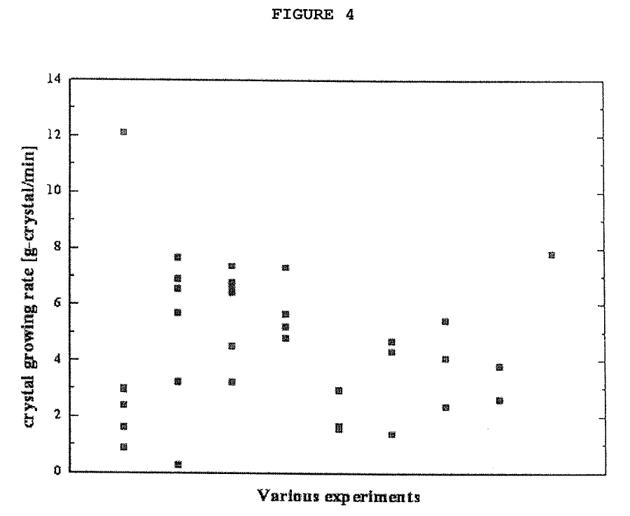

The operations of the Example 1 were 32 times repeated. FIGS. 3 and 4 show the distribution efficiency K_{d} and the crystal growing rate of the solidified LiCl salt, respectively.

The separation efficiency of the radioactive nuclide may be quantified through the distribution efficiency. The distribution efficiency K_{d} is defined as a weight fraction of CS and Sr included in LiCl salt per unit weight (g), which is formed through the solidification.

When the distribution efficiency K_{d} becomes less than about 0.1, the separation efficiency of Cs and Sr of about 90% or more may be obtained.

The initial temperature of the LiCl salt waste containing Cs and Sr, and the mean distribution efficiency K_{d} and the crystal growing rate of the solidified LiCl salt according to the Example 1 are described in the following Table 1.

### COMPARATIVE EXAMPLE 1

Except that the initial temperature of the LiCl salt waste is regulated to be about 715° C., the similar process to that of the Example 1 was performed. At the time of stopping the operation, the temperature of the LiCl salt waste was about 640° C., and the temperature of the outlet of the crystallizer was 564° C. In this case, since the initial temperature of the LiCl salt waste was too high, the solidification of the LiCl salt was not generated in the first comparative example. FIG. 5(a) illustrates the temperature changes of the outlet of the crystallizer and the LiCl salt waste until the solidification of the LiCl salt waste is finished.

The initial temperature of the LiCl salt waste containing Cs and Sr and other experimental results according to the Comparative Example 1 are described in the following Table 1.

### COMPARATIVE EXAMPLE 2

Except that the initial temperature of the LiCl salt waste is regulated to be about 640° C., the similar process to that of the Example 1 was performed. At the time of stopping the operation, the temperature of the outlet of the crystallizer was 435° C., but the temperature of the LiCl salt waste was relatively low temperature of about 600° C. In this case, since the temperature of the LiCl salt waste was low, a large amount of the LiCl salt was solidified, but the separation efficiency of Cs and SR was too low. FIG. 5(b) illustrates the temperature changes of the outlet of the crystallizer and the LiCl salt waste until the solidification of the LiCl salt waste is finished.

The initial temperature of the LiCl salt waste containing Cs and Sr, and the mean distribution efficiency K_{d} and the crystal growing rate of the solidified LiCl salt according to the Comparative Example 2 are described in the following Table 1.

TABLE 1

| | | | Comparative | Comparative |
|---|---|---|---|---|
| | | Example 1 | Example 1 | Example 2 |
| Initial temperature | | 680 | 715 | 640 |
| of LiCl salt waste | | | | |
| containing Cs and Sr | | | | |
| (° C.) | | | | |
| Distribution | Cs | 0.0144 | — | 0.83 |
| Efficiency | Sr | 0.019 | — | 0.73 |
| (K_{d}) | | | | |

| | | | |
|---|---|---|---|
| Crystal Growing Rate | 2.8 | unsolidified | 8.8 |
| (g/min) | | | |

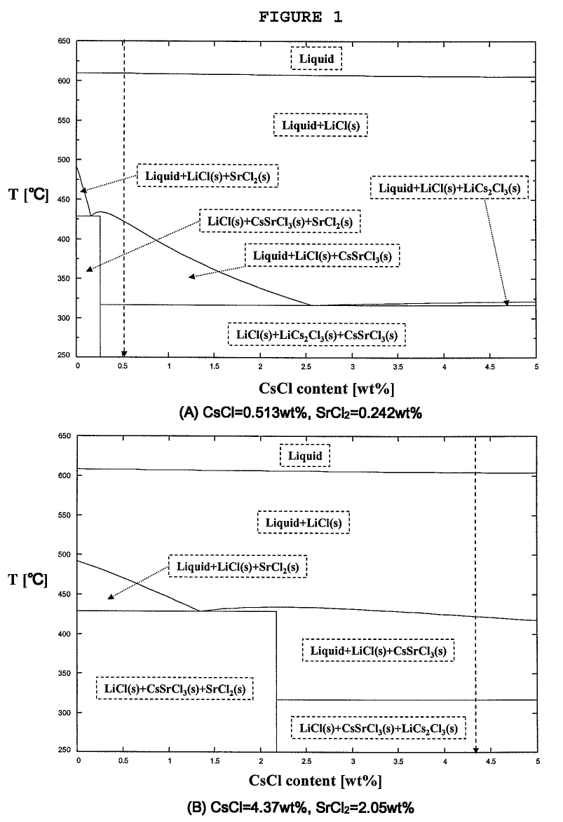

FIG. 1 is a three-component phase diagram of LiCl—CsCl—SrCl2. FIG. 2 illustrates an apparatus of recycling LiCl salt waste including radionuclides.

FIG. 2(a) illustrates that LiCl salt wastes including radionuclides are solidified into a LiCl salt. FIG. 2(b) illustrates that the solidified LiCl salt is re-melted in a melting furnace.

FIG. 3 illustrates a distribution efficiency coefficient and removal rate of Cs/Sr in a solidified salt according to the Example 1 of the present invention.

FIG. 4 illustrates a crystal growing rate of a solidified LiCl salt according to the Example 1 of the present invention.

FIG. 5(a) illustrates changes of temperature (Out T (° C.)) of an outlet of a crystallizer and temperature (salt T (° C.)) of LiCl wastes including radionuclides according to the Comparative Example 1 of the present invention. FIG. 5(b) illustrates changes of temperature (Out T (° C.)) of an outlet of a crystallizer and temperature (salt T (° C.)) of LiCl wastes including radionuclides according to the Comparative Example 2 of the present invention. FIG. 5(c) illustrates changes of temperature (Out T (° C.)) of an outlet of a crystallizer and temperature (salt T (° C.)) of LiCl wastes including radionuclides according to the Example 1 of the present invention.

The present invention has an advantage of recycling LiCl salt wastes through a simple process and a high yield by separating radionuclides and LiCl salt compared to related-art method and apparatus of recycling LiCl salt wastes including radionuclides.

The present invention can simplify the total process because an inorganic ion exchange medium (for example, zeolite) and a precipitator (for example, carbonate, phosphate, and the like) are not added to separate Cs and Sr. Also, the present invention has an advantage of improving economic efficiency and significantly reducing the amount of wastes for final disposal by separating pure LiCl salt at a high yield to recycle the LiCl salt in an electro-reduction process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of recycling LiCl salt wastes comprising radionuclides, the method comprising:
a) solidifying a LiCl salt contained in the LiCl salt wastes and contacting the outer wall of a housing, by charging a crystallizer comprising the housing having an internal accommodating space and an air cooler in the internal accommodating space into a crystallizing furnace accommodating the LiCl salt wastes comprising the radionuclides, and by cooling the housing to a temperature of two-phase region where the liquid state and the solid state of the LiCl salt waste coexist;
b) separating the crystallizer where the LiCl salt is solidified from the crystallizing furnace; and
c) recycling the LiCl salt by heating the separated crystallizer to melt the solidified LiCl salt.

2. The method as set forth in claim 1, wherein the radionuclide is at least one selected from Cs and Sr groups.

3. The method as set forth in claim 1, wherein the solidifying of the LiCl salt comprises cooling the housing to a temperature from about 490° C. to about 610° C.

4. The method as set forth in claim 1, wherein the solidifying of the LiCl salt comprises cooling the housing by passing a cooling air through the cooler via an inlet and an outlet in the crystallizer, and a temperature change (ΔT) of the outlet ranges from about 10° C. to about 20° C.

5. The method as set forth in claim 1, wherein, in the separating of the crystallizer, the LiCl salt solidified in the crystallizer comprises about 80% to about 95% of the total weight of the LiCl salt waste comprising the radionuclides.

6. The method as set forth in claim 1, wherein, in the solidifying of the LiCl salt, a crystal growing rate of the solidified LiCl salt ranges from about 2 g/min to about 6 g/min.

7. The method as set forth in claim 1, wherein, in the solidifying of the LiCl salt, the initial temperature of the LiCl salt waste comprising the radionuclide ranges from about 650° C. to about 710° C.

8. An apparatus of recycling LiCl salt wastes comprising at least one radionuclide selected from Cs and Sr groups, the apparatus comprising:
a crystallizing furnace accommodating the LiCl salt wastes comprising the radionuclide;
a crystallizer charged into the LiCl salt wastes comprising the radionuclide accommodated in the crystallizing furnace, comprising a housing having an internal accommodating space and comprising an air-cooler in the internal accommodating space, wherein the housing is cooled by the air-cooler to solidify a LiCl salt of the LiCl salt waste contacting the outer wall of the housing; and
a melting furnace separating the LiCl salt from the radionuclide by accommodating the crystallizer where the LiCl salt separated from the crystallizing furnace is solidified, wherein the solidified LiCl salt on the outer wall of the housing is melted.

9. The apparatus as set forth in claim 8, wherein the crystallizer comprises:
an inlet supplying a cooling air to the internal accommodating space of the housing;
a baffle maintaining the internal accommodating space of the housing at a predetermined temperature by diffusing the cooling air; and
an outlet discharging the cooling air supplied to the internal accommodating space of the housing.

10. The apparatus as set forth in claim 9, wherein a plurality of baffles are laterally and alternately arranged to form a cooling air-flow path having a zigzag pattern.

11. The apparatus as set forth in claim 9, wherein the crystallizer further comprises a thermometer for measuring the temperature of the cooling air accommodated in the housing.

12. The apparatus as set forth in claim 9, wherein the crystallizer further comprises a flow regulator for maintaining the internal accommodating space of the housing at a predetermined temperature by regulating a flow rate of a cooling air supplied from the inlet and a flow rate of a cooling air discharged to the outlet.

13. The apparatus as set forth in claim 8, wherein the crystallizing furnace further comprises a heater for heating the accommodated LiCl salt waste to prevent an excessive cooling by the crystallizer.
